(19) United States
(12) Patent Application Publication
(10) Pub. No.: US 2020/0366516 A1
(43) Pub. Date: Nov. 19, 2020

(54) ELECTRONIC DEVICE AND METHOD FOR REGISTERING SMART HOME DEVICE IN SMART HOME SYSTEM

(71) Applicant: SAMSUNG ELECTRONICS CO., LTD., Suwon-si (KR)

(72) Inventors: Choonkyoung MOON, Suwon-si (KR); Jangwoo LEE, Seoul (KR); Eunkyung YOO, Seoul (KR); Jaok KOO, Yongin-si (KR); Hyunsoo NAH, Seoul (KR)

(21) Appl. No.: 16/985,006

(22) Filed: Aug. 4, 2020

Related U.S. Application Data
(63) Continuation of application No. 15/435,604, filed on Feb. 17, 2017.

(30) Foreign Application Priority Data
Feb. 18, 2016 (KR) 10-2016-0019325

(51) Int. Cl. H04L 12/28; H04L 12/24

(52) U.S. Cl. CPC H04L 12/2809; H04L 2012/2841; H04L 41/22; H04L 41/0883

(57) ABSTRACT

An electronic device and method for registering a smart home device in a smart home system are provided. In various example embodiments, the electronic device receives a registration signal from the smart home device and collects information about the smart home device by analyzing the received registration signal. Then the electronic device requests a registration confirmation by providing the information about the smart home device through a display and also requests home network connection information when the registration confirmation is received. When the home network connection information is received, the electronic device connects the smart home device to a home network by transmitting the home network connection information to the smart home device.

### CROSS-REFERENCE TO RELATED APPLICATION

This application is based on and claims priority under 35 U.S.C. § 119 to a Korean patent application filed on Feb. 18, 2016, in the Korean Intellectual Property Office and assigned Serial No. 10-2016-0019325, the disclosure of which is incorporated by reference herein in its entirety.

### TECHNICAL FIELD

The present disclosure relates generally to an electronic device and method for registering a smart home device in a smart home system.

### BACKGROUND

With the remarkable development of information communication technology, a smart home system that controls household appliances (also referred to as smart home devices) through a wired/wireless communication network is increasingly popularized. This smart home system may provide an environment for registering such household appliances in the wired/wireless network and also controlling the registered appliances by means of a smart phone.

For construction of a smart home system, a registration process of connecting household appliances to a home network, e.g., an access point (AP), is required.

By the way, this registration process is in general a complicated and time-consuming process. In addition, registration processes vary by a smart home device. Unfortunately, this often causes a user inconvenience.

### SUMMARY

Various embodiments of the present disclosure may provide an electronic device and method for registering a smart home device in a smart home system so as to simply connect the smart home device to a home network in the same or similar manner regardless of the kind of the smart home device.

According to various example embodiments of the present disclosure, an electronic device for registering a smart home device in a smart home system may include a display, a communication module comprising communication circuitry, an input unit comprising input circuitry, a memory, and a processor electrically connected to the display, the communication module, the input unit, and the memory. In this electronic device, the processor may be configured to receive a registration signal from the smart home device, to collect information about the smart home device by analyzing the received registration signal, to request a registration confirmation by providing the information about the smart home device through the display, to request home network connection information when the registration confirmation is received, and to connect the smart home device to a home network by transmitting the home network connection information to the smart home device when the home network connection information is received.

According to various example embodiments of the present disclosure, an electronic device for registering a smart home device in a smart home system may include a display, a communication module comprising communication circuitry, an input unit comprising input circuitry, a memory, and a processor electrically connected to the display, the communication module, the input unit, and the memory. In this electronic device, the processor may be configured to receive a registration signal from the smart home device, to determine whether the registration signal is no longer generated, to collect information about the smart home device by analyzing the received registration signal if there is no generation of the registration signal, to request a registration confirmation by providing the information about the smart home device through the display if the registration signal is received again, to request home network connection information when the registration confirmation is received, and to connect the smart home device to a home network by transmitting the home network connection information to the smart home device when the home network connection information is received.

According to various example embodiments of the present disclosure, an electronic device for registering a smart home device in a smart home system may include a display, a communication module comprising communication circuitry, an input unit comprising input circuitry, a memory, and a processor electrically connected to the display, the communication module, the input unit, and the memory. In this electronic device, the processor may be configured to request, through the display, to move a remote controller near the smart home device, to identify the smart home device based on a notification received through the remote controller if the smart home device recognizes an approach of the remote controller and generates a notification, to request a registration confirmation by providing information about the smart home device through the display, to request home network connection information when the registration confirmation is received through the input unit, and to connect the smart home device to a home network by transmitting the home network connection information to the smart home device when the home network connection information is received.

According to various example embodiments of the present disclosure, a method for registering a smart home device in a smart home system by an electronic device may include operations of receiving a registration signal from the smart home device; collecting information about the smart home device by analyzing the received registration signal; requesting a registration confirmation by providing the information about the smart home device through a display; requesting home network connection information when the registration confirmation is received; and connecting the smart home device to a home network by transmitting the home network connection information to the smart home device when the home network connection information is received.

According to various example embodiments of the present disclosure, a method for registering a smart home device in a smart home system by an electronic device may include operations of receiving a registration signal from the smart home device; determining whether the registration signal is no longer generated; if there is no longer a generation of the registration signal, collecting information about the smart home device by analyzing the received registration signal; requesting a registration confirmation by providing the information about the smart home device through a display if the registration signal is received again; requesting home network connection information when the registration confirmation is received; and connecting the smart home device to a home network by transmitting the home network connection information to the smart home device when the home network connection information is received.

According to various example embodiments of the present disclosure, a method for registering a smart home device in a smart home system by an electronic device may include operations of requesting, through a display, to move a remote controller near the smart home device; identifying the smart home device according to a notification received through the remote controller if the smart home device recognizes an approach of the remote controller and generates a notification; requesting a registration confirmation by providing information about the smart home device through the display; requesting home network connection information when the registration confirmation is received through the input unit; and connecting the smart home device to a home network by transmitting the home network connection information to the smart home device when the home network connection information is received.

### BRIEF DESCRIPTION OF THE DRAWINGS

The above and other aspects, features and attendant advantages of the present disclosure will become more apparent and readily understood from the following detailed description, taken in conjunction with the accompanying drawings, in which like reference numerals refer to like elements, and wherein:

FIG. 1 is a block diagram illustrating an example network environment including an electronic device according to various example embodiments of the present disclosure;

FIG. 2 is a block diagram illustrating an example electronic device according to various example embodiments of the present disclosure;

FIG. 3 is a block diagram illustrating an example program module according to various example embodiments of the present disclosure;

FIG. 4 is a diagram illustrating an example smart home system according to various example embodiments of the present disclosure;

FIG. 5 is a flow diagram illustrating an example process of registering a smart home device in a home network according to an example embodiment of the present disclosure;

FIGS. 6A, 6B, 6C and 6D are diagrams illustrating an example registration process illustrated in FIG. 5;

FIG. 7 is a flow diagram illustrating an example process of registering a smart home device in a home network according to another example embodiment of the present disclosure;

FIGS. 8A, 8B, 8C and 8D are diagrams illustrating an example registration process illustrated in FIG. 7;

FIGS. 9A, 9B, 9C, 9D and 9E are diagrams illustrating an example service in which a smart TV displays a detailed registration process for a smart home device through synchronization with a user interface of another registration supporting device according to still another example embodiment of the present disclosure;

FIGS. 10A, 10B, 10C and 10D are diagrams illustrating an example process of registering a smart home device in a home network according to yet another example embodiment of the present disclosure;

FIGS. 11A and 11B are diagrams illustrating an example service provided by a smart TV after registration of a smart home device according to an example embodiment of the present disclosure;

FIGS. 12A, 12B, 12C and 12D are diagrams illustrating an example service provided by a smart TV after registration of a smart home device according to another example embodiment of the present disclosure;

FIGS. 13A, 13B, 13C and 13D are diagrams illustrating an example method for registering a new smart TV in an already constructed smart home system according to an example embodiment of the present disclosure; and

FIGS. 14A, 14B, 14C and 14D are diagrams illustrating an example service provided after initial registration of a new smart TV according to an example embodiment of the present disclosure.

### DETAILED DESCRIPTION

The following description with reference to the accompanying drawings is provided to assist in a comprehensive understanding of various example embodiments of the present disclosure as defined by the claims and their equivalents. It includes various specific details to assist in that understanding but these are to be regarded as merely examples. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used to enable a clear and consistent understanding of the present disclosure. Accordingly, it should be apparent to those skilled in the art that the following description of various example embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expressions such as “include” and “may include” may denote the presence of the disclosed functions, operations, and constituent elements and do not limit one or more additional functions, operations, and constituent elements. Terms such as “include” and/or “have” may be construed to denote a certain characteristic, number, operation, constituent element, component or a combination thereof, but may not be construed to exclude the existence of or a possibility of addition of one or more other characteristics, numbers, operations, constituent elements, components or combinations thereof.

Furthermore, in the present disclosure, the expression “and/or” includes any and all combinations of the associated listed words. For example, the expression “A and/or B” may include A, may include B, or may include both A and B.

In the present disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them are user devices. For example, a first element could be termed a second element, and similarly, a second element could be also termed a first element without departing from the scope of the present disclosure.

In the case where a component is referred to as being “connected” or “accessed” to other component, it should be understood that not only the component is directly connected or accessed to the other component, but also there may exist another component between them. Meanwhile, in the case where a component is referred to as being “directly connected” or “directly accessed” to other component, it should be understood that there is no component therebetween. The terms used in the present disclosure are only used to describe specific various embodiments, and are not intended to limit the present disclosure. As used herein, the singular forms are intended to include the plural forms as well, unless the context clearly indicates otherwise. Singular forms are intended to include plural forms unless the context clearly indicates otherwise.

An electronic device according to the present disclosure may be a device including a communication function. For example, the device corresponds to a combination of at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital audio player, a mobile medical device, an electronic bracelet, an electronic necklace, an electronic accessory, a camera, a wearable device, an electronic clock, a wrist watch, home appliances (for example, an air-conditioner, vacuum, an oven, a microwave, a washing machine, an air cleaner, and the like), an artificial intelligence robot, a TeleVision (TV), a Digital Video Disk (DVD) player, an audio device, various medical devices (for example, Magnetic Resonance Angiography (MRA), Magnetic Resonance Imaging (MRI), Computed Tomography (CT), a scanning machine, a ultrasonic wave device, or the like), a navigation device, a Global Positioning System (GPS) receiver, an Event Data Recorder (EDR), a Flight Data Recorder (FDR), a set-top box, a TV box (for example, Samsung HomeSync™, Apple TV™, or Google TV™), an electronic dictionary, vehicle infotainment device, an electronic equipment for a ship (for example, navigation equipment for a ship, gyrocompass, or the like), avionics, a security device, electronic clothes, an electronic key, a camcorder, game consoles, a Head-Mounted Display (HMD), a flat panel display device, an electronic frame, an electronic album, furniture or a portion of a building/structure that includes a communication function, an electronic board, an electronic signature receiving device, a projector, or the like, but is not limited thereto. It will be apparent to those skilled in the art that the electronic device according to the present disclosure is not limited to the aforementioned devices.

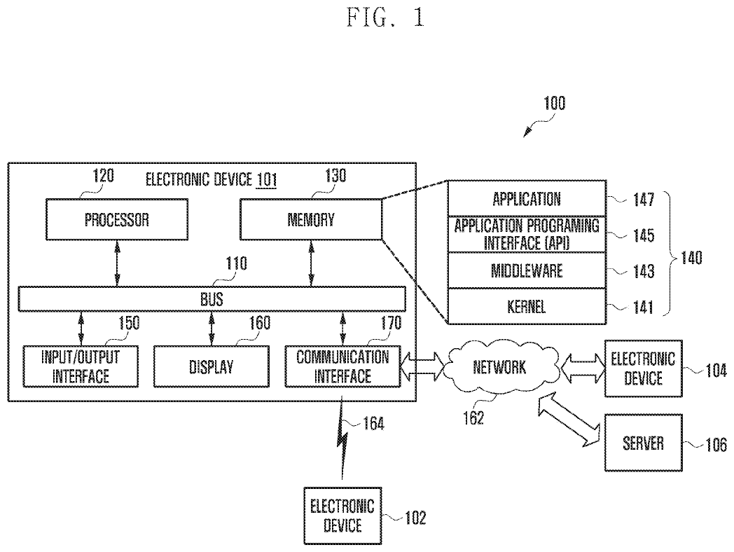

FIG. 1 is a block diagram illustrating an example configuration of an electronic device in a network environment 100 according to an example embodiment of the present disclosure.

Referring to FIG. 1, the electronic device 101 may include a bus 110, a processor (e.g., including processing circuitry) 120, a memory 130, an input/output interface (e.g., including input/output circuitry 150, a display 160, a communication interface (e.g., including interface circuitry) 170, and other similar and/or suitable components.

The bus 110 may be a circuit which interconnects the above-described elements and delivers a communication (e.g., a control message) between the above-described elements.

The processor 120 may receive commands from the above-described other elements (e.g., the memory 130, the input/output interface 150, the display 160, the communication interface 170, etc.) through the bus 110, may interpret the received commands, and may execute calculation or data processing according to the interpreted commands.

The memory 130 may store commands or data received from the processor 120 or other elements (e.g., the input/output interface 150, the display 160, the communication interface 170, etc.) or generated by the processor 120 or the other elements. The memory 130 may include programming modules, such as a kernel 141, middleware 143, an Application Programming Interface (API) 145, an application 147, and the like. Each of the above-described programming modules may be implemented in software, firmware, hardware, or a combination of two or more thereof.

The kernel 141 may control or manage system resources (e.g., the bus 110, the processor 120, the memory 130, etc.) used to execute operations or functions implemented by other programming modules (e.g., the middleware 143, the API 145, and the application 147). Also, the kernel 131 may provide an interface capable of accessing and controlling or managing the individual elements of the electronic device 100 by using the middleware 143, the API 145, or the application 147.

The middleware 143 may serve to go between the API 145 or the application 147 and the kernel 141 in such a manner that the API 145 or the application 147 communicates with the kernel 141 and exchanges data therewith. Also, in relation to work requests received from one or more applications 147 and/or the middleware 143, for example, may perform load balancing of the work requests by using a method of assigning a priority, in which system resources (e.g., the bus 110, the processor 120, the memory 130, etc.) of the electronic device 100 can be used, to at least one of the one or more applications 147.

The API 145 is an interface through which the application 147 is capable of controlling a function provided by the kernel 141 or the middleware 143, and may include, for example, at least one interface or function for file control, window control, image processing, character control, or the like.

The input/output interface 150 may include various input/output circuitry and may, for example, may receive a command or data as input from a user, and may deliver the received command or data to the processor 120 or the memory 130 through the bus 110. The display 160 may display a video, an image, data, or the like to the user.

The communication interface 170 may include various communication circuitry and may connect communication between another electronic device 102 and the electronic device 101. The communication interface 170 may support a predetermined short-range communication protocol 164 (e.g., Wi-Fi, BlueTooth (BT), and Near Field Communication (NFC)), or predetermined network communication 162 (e.g., the Internet, a Local Area Network (LAN), a Wide Area Network (WAN), a telecommunication network, a cellular network, a satellite network, a Plain Old Telephone Service (POTS), or the like). Each of the electronic devices 102 and 104 may be a device which is identical (e.g., of an identical type) to or different (e.g., of a different type) from the electronic device 101. Further, the communication interface 170 may connect communication between a server 106 and the electronic device 101 via the network 162.

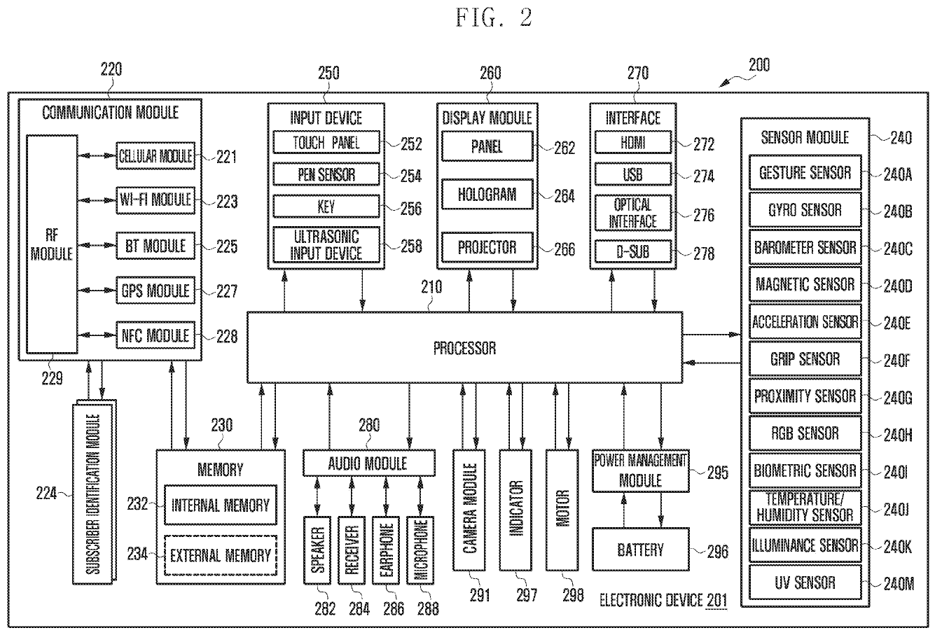

FIG. 2 is a block diagram 200 illustrating an example configuration of an electronic device 201 according to an example embodiment of the present disclosure.

The electronic device 201 may be, for example, the electronic device 101 illustrated in FIG. 1.

Referring to FIG. 2, the electronic device may include one or more processors (e.g., including processing circuitry) 210, a communication module (e.g., including communication circuitry) 220, a Subscriber Identification Module (SIM) card 224, a memory 230, a sensor module 240, a input device (e.g., including input circuitry) 250, a display module 260, an interface (e.g., including interface circuitry) 270, an audio module 280, a camera module 291, a power management module 295, a battery 296, an indicator 297, a motor 298 and any other similar and/or suitable components.

The Application Processor (AP) 210 (e.g., the processor 120) may include various processing circuitry, such as, for example, and without limitation, a dedicated processor, a CPU, one or more Application Processors (APs), or one or more Communication Processors (CPs). The processor 210 may be, for example, the processor 120 illustrated in FIG. 1. The AP 210 is illustrated as being included in the processor 210 in FIG. 2, but may be included in different Integrated Circuit (IC) packages, respectively. According to an embodiment of the present disclosure, the AP 210 may be included in one IC package.

The AP 210 may execute an Operating System (OS) or an application program, and thereby may control multiple hardware or software elements connected to the AP 210 and may perform processing of and arithmetic operations on various data including multimedia data. The AP 210 may be implemented by, for example, a System on Chip (SoC). According to an embodiment of the present disclosure, the AP 210 may further include a Graphical Processing Unit (GPU) (not illustrated).

The AP 210 may manage a data line and may convert a communication protocol in the case of communication between the electronic device (e.g., the electronic device 100) including the hardware 200 and different electronic devices connected to the electronic device through the network. The AP 210 may be implemented by, for example, a SoC. According to an embodiment of the present disclosure, the AP 210 may perform at least some of multimedia control functions. The AP 210, for example, may distinguish and authenticate a terminal in a communication network by using a subscriber identification module (e.g., the SIM card 224). Also, the AP 210 may provide the user with services, such as a voice telephony call, a video telephony call, a text message, packet data, and the like.

Further, the AP 210 may control the transmission and reception of data by the communication module 220. In FIG. 2, the elements such as the AP 220, the power management module 295, the memory 230, and the like are illustrated as elements separate from the AP 210. However, according to an embodiment of the present disclosure, the AP 210 may include at least some (e.g., the CP) of the above-described elements.

According to an embodiment of the present disclosure, the AP 210 may load, to a volatile memory, a command or data received from at least one of a non-volatile memory and other elements connected to each of the AP 210, and may process the loaded command or data. Also, the AP 210 may store, in a non-volatile memory, data received from or generated by at least one of the other elements.

The SIM card 224 may be a card implementing a subscriber identification module, and may be inserted into a slot formed in a particular portion of the electronic device 100. The SIM card 224 may include unique identification information (e.g., Integrated Circuit Card IDentifier (ICCID)) or subscriber information (e.g., International Mobile Subscriber Identity (IMSI)).

The memory 230 may include an internal memory 232 and/or an external memory 234. The memory 230 may be, for example, the memory 130 illustrated in FIG. 1. The internal memory 232 may include, for example, at least one of a volatile memory (e.g., a Dynamic RAM (DRAM), a Static RAM (SRAM), a Synchronous Dynamic RAM (SDRAM), etc.), and a non-volatile memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a Not AND (NAND) flash memory, a Not OR (NOR) flash memory, etc.). According to an embodiment of the present disclosure, the internal memory 232 may be in the form of a Solid State Drive (SSD). The external memory 234 may further include a flash drive, for example, a Compact Flash (CF), a Secure Digital (SD), a Micro-Secure Digital (Micro-SD), a Mini-Secure Digital (Mini-SD), an extreme Digital (xD), a memory stick, or the like.

The communication module 220 may include various communication circuitry, such as, for example, and without limitation, a cellular module 221, a wireless communication module 223 or a Radio Frequency (RF) module 229. The communication module 220 may be, for example, the communication interface 170 illustrated in FIG. 1. The communication module 220 may include, for example, a Wi-Fi module 223, a BT module 225, a GPS module 227, and/or an NFC module 229. For example, the wireless communication module 220 may provide a wireless communication function by using a radio frequency. Additionally or alternatively, the wireless communication module 220 may include a network interface (e.g., a LAN card), a modulator/demodulator (modem), or the like for connecting the hardware 200 to a network (e.g., the Internet, a LAN, a WAN, a telecommunication network, a cellular network, a satellite network, a POTS, or the like).

The RF module 229 may be used for transmission and reception of data, for example, transmission and reception of RF signals or called electronic signals. Although not illustrated, the RF unit 229 may include, for example, a transceiver, a Power Amplifier Module (PAM), a frequency filter, a Low Noise Amplifier (LNA), or the like. Also, the RF module 229 may further include a component for transmitting and receiving electromagnetic waves in a free space in a wireless communication, for example, a conductor, a conductive wire, or the like.

The sensor module 240 may include, for example, at least one of a gesture sensor 240A, a gyro sensor 240B, an barometer sensor 240C, a magnetic sensor 240D, an acceleration sensor 240E, a grip sensor 240F, a proximity sensor 240G, a Red, Green and Blue (RGB) sensor 240H, a biometric sensor 240I, a temperature/humidity sensor 240J, an illuminance sensor 240K, and a Ultra Violet (UV) sensor 240M. The sensor module 240 may measure a physical quantity or may sense an operating state of the electronic device 100, and may convert the measured or sensed information to an electrical signal. Additionally/alternatively, the sensor module 240 may include, for example, an E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), a fingerprint sensor (not illustrated), and the like. Additionally or alternatively, the sensor module 240 may include, for example, an E-nose sensor (not illustrated), an EMG sensor (not illustrated), an EEG sensor (not illustrated), an ECG sensor (not illustrated), a fingerprint sensor, and the like. The sensor module 240 may further include a control circuit (not illustrated) for controlling one or more sensors included therein.

The input device 250 may include various input circuitry, such as, for example, and without limitation, a touch panel 252, a pen sensor 254 (e.g., a digital pen sensor), keys 256, and an ultrasonic input unit 258. The input device 250 may be, for example, the user input module 140 illustrated in FIG. 1. The touch panel 252 may recognize a touch input in at least one of, for example, a capacitive scheme, a resistive scheme, an infrared scheme, and an acoustic wave scheme. Also, the touch panel 252 may further include a controller (not illustrated). In the capacitive type, the touch panel 252 is capable of recognizing proximity as well as a direct touch. The touch panel 252 may further include a tactile layer (not illustrated). In this event, the touch panel 252 may provide a tactile response to the user.

The pen sensor 254 (e.g., a digital pen sensor), for example, may be implemented by using a method identical or similar to a method of receiving a touch input from the user, or by using a separate sheet for recognition. For example, a key pad or a touch key may be used as the keys 256. The ultrasonic input unit 258 enables the terminal to sense a sound wave by using a microphone (e.g., a microphone 288) of the terminal through a pen generating an ultrasonic signal, and to identify data. The ultrasonic input unit 258 is capable of wireless recognition. According to an embodiment of the present disclosure, the hardware 200 may receive a user input from an external device (e.g., a network, a computer, or a server), which is connected to the communication module 230, through the communication module 230.

The display module 260 may include a panel 262, a hologram 264, or projector 266. The display module 260 may be, for example, the display module 150 illustrated in FIG. 1. The panel 262 may be, for example, a Liquid Crystal Display (LCD) and an Active Matrix Organic Light Emitting Diode (AM-OLED) display, or the like, but is not limited thereto. The panel 262 may be implemented so as to be, for example, flexible, transparent, or wearable. The panel 262 may include the touch panel 252 and one module. The hologram 264 may display a three-dimensional image in the air by using interference of light. According to an embodiment of the present disclosure, the display module 260 may further include a control circuit for controlling the panel 262 or the hologram 264.

The interface 270 may include various interface circuitry, such as, for example, and without limitation, a High-Definition Multimedia Interface (HDMI) 272, a Universal Serial Bus (USB) 274, an optical interface 276, and a D-subminiature (D-sub) 278. Additionally or alternatively, the interface 270 may include, for example, SD/Multi-Media Card (MMC) (not illustrated) or Infrared Data Association (IrDA) (not illustrated).

The audio module 280 may include, for example, and without limitation, a codec and may bidirectionally convert between a voice and an electrical signal. The audio codec 280 may convert voice information, which is input to or output from the audio codec 280, through, for example, a speaker 282, a receiver 284, an earphone 286, the microphone 288 or the like.

The camera module 291 may capture an image and a moving image. According to an embodiment, the camera module 291 may include one or more image sensors (e.g., a front lens or a back lens), an Image Signal Processor (ISP) (not illustrated), and a flash LED (not illustrated).

The power management module 295 may manage power of the hardware 200. Although not illustrated, the power management module 295 may include, for example, a Power Management Integrated Circuit (PMIC), a charger Integrated Circuit (IC), or a battery fuel gauge.

The PMIC may be mounted to, for example, an IC or a SoC semiconductor. Charging methods may be classified into a wired charging method and a wireless charging method. The charger IC may charge a battery, and may prevent an overvoltage or an overcurrent from a charger to the battery. According to an embodiment of the present disclosure, the charger IC may include a charger IC for at least one of the wired charging method and the wireless charging method. Examples of the wireless charging method may include a magnetic resonance method, a magnetic induction method, an electromagnetic method, and the like. Additional circuits (e.g., a coil loop, a resonance circuit, a rectifier, etc.) for wireless charging may be added in order to perform the wireless charging.

The battery fuel gauge may measure, for example, a residual quantity of the battery 296, or a voltage, a current or a temperature during the charging. The battery 296 may supply power by generating electricity, and may be, for example, a rechargeable battery.

The indicator 297 may indicate particular states of the hardware 200 or a part (e.g., the AP 211) of the hardware 200, for example, a booting state, a message state, a charging state and the like. The motor 298 may convert an electrical signal into a mechanical vibration. The processor 210 may control the sensor module 240.

Although not illustrated, the hardware 200 may include a processing unit (e.g., a GPU) for supporting a module TV. The processing unit for supporting a module TV may process media data according to standards such as, for example, Digital Multimedia Broadcasting (DMB), Digital Video Broadcasting (DVB), media flow, and the like. Each of the above-described elements of the hardware 200 according to an embodiment of the present disclosure may include one or more components, and the name of the relevant element may change depending on the type of electronic device. The hardware 200 according to an embodiment of the present disclosure may include at least one of the above-described elements. Some of the above-described elements may be omitted from the hardware 200, or the hardware 200 may further include additional elements. Also, some of the elements of the hardware 200 according to an embodiment of the present disclosure may be combined into one entity, which may perform functions identical to those of the relevant elements before the combination.

The term “module” used in the present disclosure may refer to, for example, a unit including one or more combinations of hardware, software, and firmware. The “module” may be used interchangeably with a term, such as “unit,” “logic,” “logical block,” “component,” “circuit,” or the like. The “module” may be a minimum unit of a component formed as one body or a part thereof. The “module” may be a minimum unit for performing one or more functions or a part thereof. The “module” may be implemented mechanically or electronically. For example, the “module” according to an example embodiment of the present disclosure may include at least one of a dedicated processor, a CPU, an Application-Specific Integrated Circuit (ASIC) chip, a Field-Programmable Gate Array (FPGA), and a programmable-logic device for performing certain operations which have been known or are to be developed in the future.

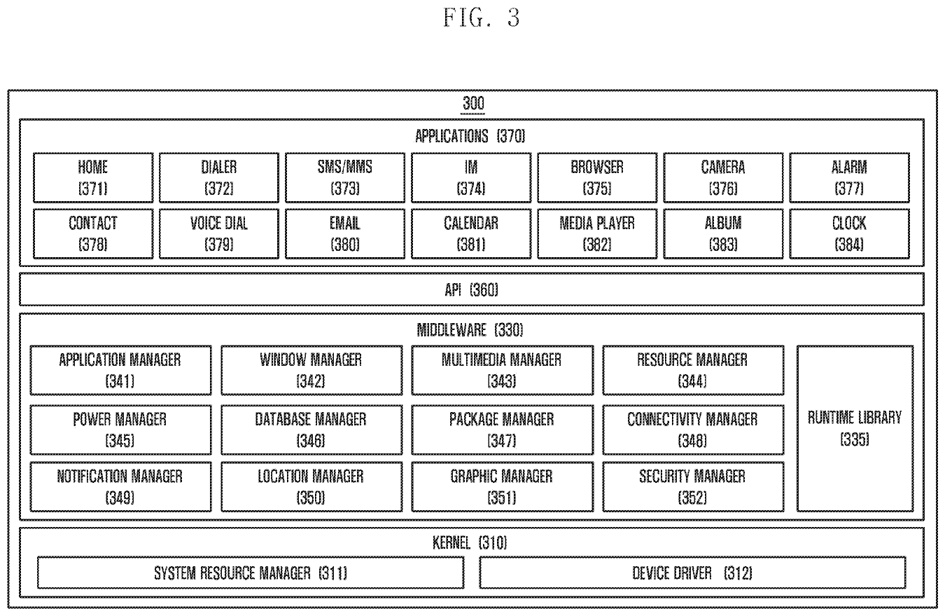

FIG. 3 is a block diagram illustrating an example configuration of a programming module 300 according to an example embodiment of the present disclosure.

The programming module 300 may be included (or stored) in the electronic device 101 (e.g., the memory 130) or may be included (or stored) in the electronic device 201 (e.g., the memory 230) illustrated in FIG. 1. At least a part of the programming module 300 may be implemented in software, firmware, hardware, or a combination of two or more thereof. The programming module 300 may be implemented in hardware (e.g., the hardware 200), and may include an OS controlling resources related to an electronic device (e.g., the electronic device 100) and/or various applications (e.g., an application 370) executed in the OS. For example, the OS may be Android, iOS, Windows, Symbian, Tizen, Bada, and the like.

Referring to FIG. 3, the programming module 300 may include a kernel 310, a middleware 330, an API 360, and/or the application 370.

The kernel 310 (e.g., the kernel 131) may include a system resource manager 311 and/or a device driver 312. The system resource manager 311 may include, for example, a process manager (not illustrated), a memory manager (not illustrated), and a file system manager (not illustrated). The system resource manager 311 may perform the control, allocation, recovery, and/or the like of system resources. The device driver 312 may include, for example, a display driver (not illustrated), a camera driver (not illustrated), a Bluetooth driver (not illustrated), a shared memory driver (not illustrated), a USB driver (not illustrated), a keypad driver (not illustrated), a Wi-Fi driver (not illustrated), and/or an audio driver (not illustrated). Also, according to an embodiment of the present disclosure, the device driver 312 may include an Inter-Process Communication (IPC) driver (not illustrated).

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 132) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370. According to an embodiment of the present disclosure, the runtime library 335 may perform functions which are related to input and output, the management of a memory, an arithmetic function, and/or the like.

The application manager 341 may manage, for example, a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a Basic Input/Output System (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as, for example, Wi-Fi and Bluetooth. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present disclosure, when the electronic device (e.g., the electronic device 100) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 360 (e.g., the API 133) is a set of API programming functions, and may be provided with a different configuration according to an OS. In the case of Android or iOS, for example, one API set may be provided to each platform. In the case of Tizen, for example, two or more API sets may be provided to each platform.

The applications 370 (e.g., the applications 134) may include, for example, a preloaded application and/or a third party application. The applications 370 (e.g., the applications 134) may include, for example, a home application 371, a dialer application 372, a Short Message Service (SMS)/Multimedia Message Service (MIMS) application 373, an Instant Message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 300 may be implemented by instructions stored in a non-transitory computer-readable storage medium. When the instructions are executed by one or more processors (e.g., the one or more processors 210), the one or more processors may perform functions corresponding to the instructions. The non-transitory computer-readable storage medium may be, for example, the memory 220. At least a part of the programming module 300 may be implemented (e.g., executed) by, for example, the one or more processors 210. At least a part of the programming module 300 may include, for example, a module, a program, a routine, a set of instructions, and/or a process for performing one or more functions.

Names of the elements of the programming module (e.g., the programming module 300) according to an embodiment of the present disclosure may change depending on the type of OS. The programming module according to an embodiment of the present disclosure may include one or more of the above-described elements. Alternatively, some of the above-described elements may be omitted from the programming module. Alternatively, the programming module may further include additional elements. The operations performed by the programming module or other elements according to an embodiment of the present disclosure may be processed in a sequential method, a parallel method, a repetitive method, or a heuristic method. Also, some of the operations may be omitted, or other operations may be added to the operations.

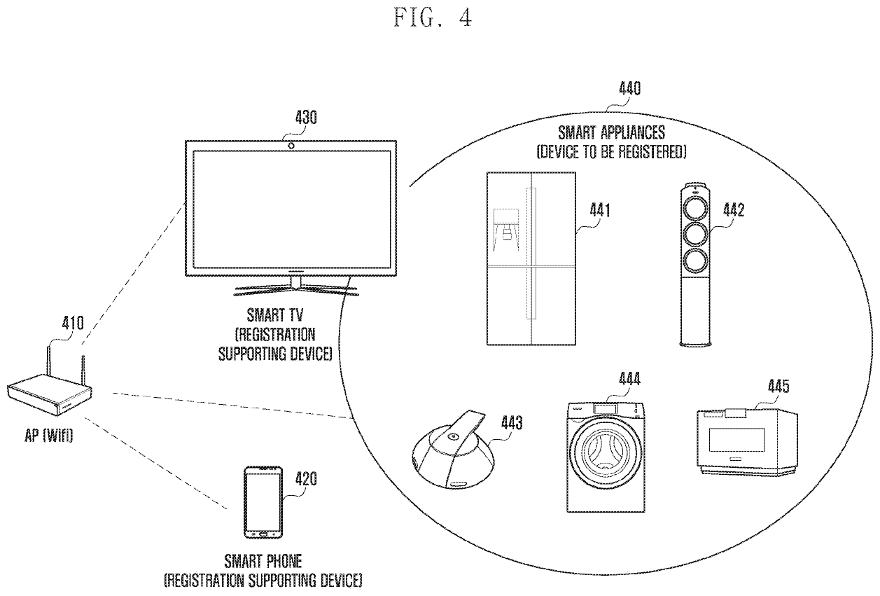

FIG. 4 is a diagram illustrating an example smart home system according to various example embodiments of the present disclosure.

Referring to FIG. 4, the smart home system according to various example embodiments may include a home network server, a smart home device, and a registration supporting device.

The home network server may include an account server, a connection server, or a service server. The account server may provide a user account management to registration supporting devices 420 and 430. The connection server may provide a communication channel for transmission of messages between the registration supporting devices 420 and 430 and a smart home device 440, using user's log-in information. The service server may store and manage information about one or more smart home devices 440. The account server, the connection server, and the service server may be functionally integrated, thus forming a single server. In some embodiments, the home network server may be implemented inside an access point (AP) 410. In this disclosure, the home network, the home network server, and the AP 410 will be considered as the same meaning and also used together.

The smart home device 440, e.g., including household appliances, is capable of access to the home network 410 and has a smart home function. For example, the smart home device 440 may include various kinds of smart household appliances such as, for example, and without limitation, a smart refrigerator 441 (hereinafter, a refrigerator), a smart air conditioner 442 (hereinafter, an air conditioner), a smart vacuum cleaner 443 (hereinafter, a cleaner), a smart washing machine 444 (hereinafter, a washer), a smart oven 445 (hereinafter, an oven), or a smart TV 430. According to some embodiments, the smart TV 430 which is one of the smart home devices 440 may also operate as a registration supporting device for registering the smart home devices 440 in the home network 410. Hereinafter, the smart TV 430 will be described as one of the registration supporting devices.

The smart home device 440 may include an AP module, a Wifi module (e.g., the Wifi module 223 in FIG. 2), or a Bluetooth module (e.g., the Bluetooth module 225 in FIG. 2), each of which performs a wireless communication, e.g., a short range communication. The AP module of the smart home device 440, which is designed for registering the smart home device 440 in the home network, may operate differently from a normal AP module. For example, the AP module of the smart home device 440 may transmit a beacon frame while operating temporarily only at the beginning when the smart home device 440 is powered on. Thus, an external device including the registration supporting device may temporarily recognize the smart home device 440 as an AP. According to another embodiment, at the beginning when the smart home device 440 is powered on, the Bluetooth module instead of the AP module may temporarily transmit an inquiry response message based on a Bluetooth protocol. Thus, an external device including the registration supporting device may recognize the smart home device 440 as a Bluetooth device.

The registration supporting devices 420 and 430 may access the home network 410 and then provide, to a user, a function of newly registering or inquiring the smart home device 440 which accesses the home network 440. For example, the registration supporting devices 420 and 430 may be an electronic device that can download and install a smart home mobile application. The registration supporting device may include, for example, but is not limited to, at least one of the smart TV 430, a smart phone 420, a tablet PC, a mobile phone, a video phone, an e-book reader, a desktop PC, a laptop PC, a netbook computer, a workstation, a personal digital assistant (PDA), a portable multimedia player (PMP), an MP3 player, a camera, or a wearable device. Hereinafter, the smart phone 420 and the smart TV 430 will be used as an electronic device for registering the smart home device in the smart home system.

According to an embodiment of this disclosure, an electronic device, e.g., the registration supporting device, for registering the smart home device in the smart home system may include a display, a communication module (e.g., including communication circuitry), an input unit (e.g., including input circuitry), a memory, and a processor electrically connected to the display, the communication module, the input unit, and the memory. The processor may be configured to receive a registration signal from the smart home device, to collect information about the smart home device by analyzing the received registration signal, to request a registration confirmation from a user by providing the information about the smart home device through the display, to request home network connection information from the user when the registration confirmation is received from the user, and to connect the smart home device to a home network by transmitting the home network connection information to the smart home device when the home network connection information is received from the user. In this electronic device, the registration signal may include a beacon frame transmitted in a broadcasting manner by the smart home device which operates as an access point (AP), or an inquiry response message based on a Bluetooth protocol transmitted by the smart home device which operates as a Bluetooth device.

According to an embodiment of this disclosure, the above electronic device, e.g., the registration supporting device, may perform a method for registering the smart home device in the smart home system, the method including operations of receiving a registration signal from the smart home device; collecting information about the smart home device by analyzing the received registration signal; requesting a registration confirmation from a user by providing the information about the smart home device through a display; requesting home network connection information from the user when the registration confirmation is received from the user; and connecting the smart home device to a home network by transmitting the home network connection information to the smart home device when the home network connection information is received from the user. In this method, the registration signal may include a beacon frame transmitted in a broadcasting manner by the smart home device which operates as an access point (AP), or an inquiry response message based on a Bluetooth protocol transmitted by the smart home device which operates as a Bluetooth device.

The method may further include operations of, after the smart home device is connected to the home network, requesting a user's confirmation about whether to receive information associated with the smart home device; and providing the information associated with the smart home device in response to the user's confirmation. Also, the operation of requesting the user's confirmation may include operations of requesting a user's confirmation about whether to receive a basic notification about the smart home device, and requesting a user's confirmation about whether to receive a detailed notification about a current status of the smart home device, an error occurrence of the smart home device, or an operation completion of the smart home device.

According to an embodiment of this disclosure, the electronic device (or the registration supporting device) for registering the smart home device may include a display, an input unit, a memory, a communication module, and a processor.

The display (e.g., the display module 260 in FIG. 2) may display various kinds of information, including various menus of the electronic device, entered by or offered to a user. For example, the display may display various screens in connection with the use of the electronic device, such as an idle screen (or a home screen), a menu screen, a new message screen, a call screen, a scheduler screen, an address book screen, a webpage display screen, and the like. Also, under the control of the processor, the display may display a user interface offered by the smart home mobile application. This display may be formed of a liquid crystal display (LCD), an organic light emitted diode (OLED), an active matrix organic light emitted diode (AMOLED), or the like. Meanwhile, if the display is formed of a touch-screen, the display may also operate as the input unit.

The input unit (e.g., the input module 250 in FIG. 2) creates an input signal according to user's manipulations. The input unit may include input keys and function keys for setting or controlling various functions of the electronic device. For example, the input unit may transmit, to the processor, an input signal of requesting the registration of the smart home device, an input signal entered as home network connection information through a user interface of the smart home mobile application, an input signal requesting an inquiry about the smart home device connected to the home network, and the like. This input device may include various input circuitry, such as, for example, and without limitation, one or combination of input tools such as a keypad, a ball joystick, an optical joystick, a wheel key, a touch key, a touch pad, a touch screen, and the like.

The memory (e.g., the memory 230 in FIG. 2) may store an operating system (OS) of the electronic device, various programs required for essential or optional functions (e.g., a sound output function, an image viewer function, a video playback function, a broadcasting reception function, etc.), the smart home mobile application, user data, and any other communication data transmitted or received. For example, the memory may store identification information about a plurality of smart home devices registered in the home network.

The communication module (e.g., the communication module 220 in FIG. 2) may establish communication between the processor and the home network server. For example, the communication module may include various communication circuitry, such as, for example, and without limitation, the cellular module, the WiFi module, the Bluetooth module, the GNSS module, the NFC module, and the RF module as shown in FIG. 2.

The processor (e.g., the application processor 210 in FIG. 2) may control the whole operation of the electronic device, control a signal flow between internal blocks of the electronic device, and perform a data processing function. For example, the processor may include various processing circuitry, such as, for example, and without limitation, a dedicated processor, a central processing unit (CPU), a microprocessor unit (MPU), an application processor (AP), and the like. For example, the processor may include the smart home mobile application.

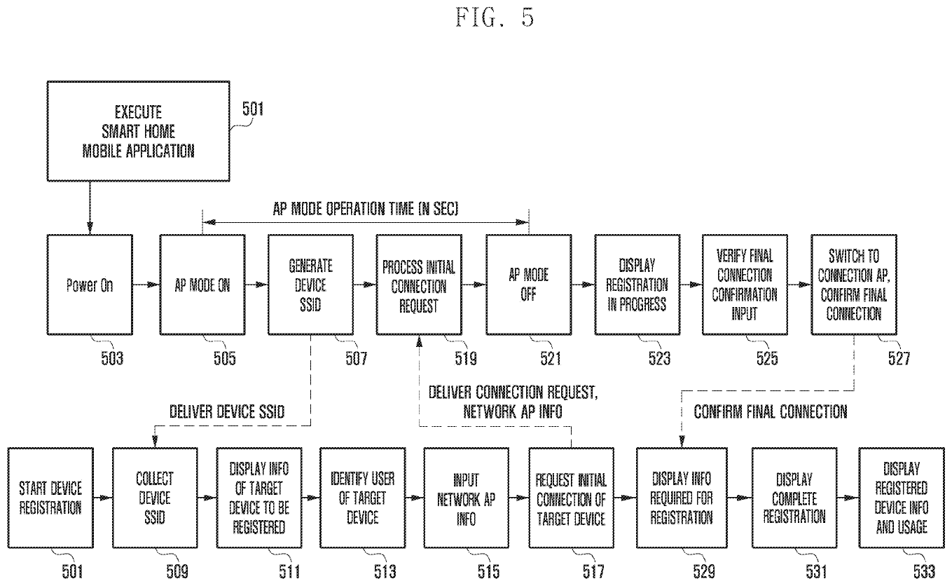

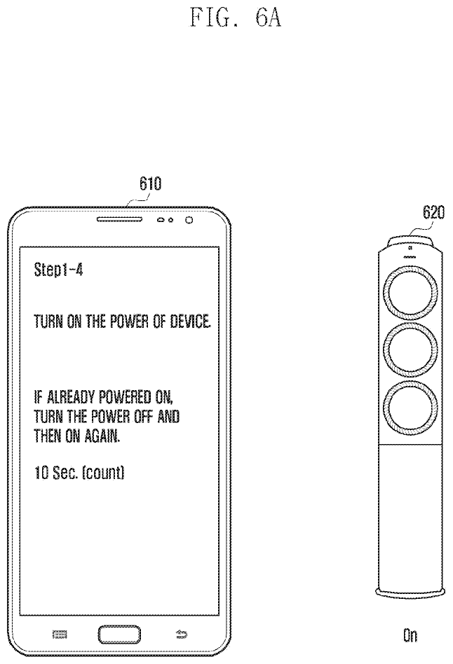

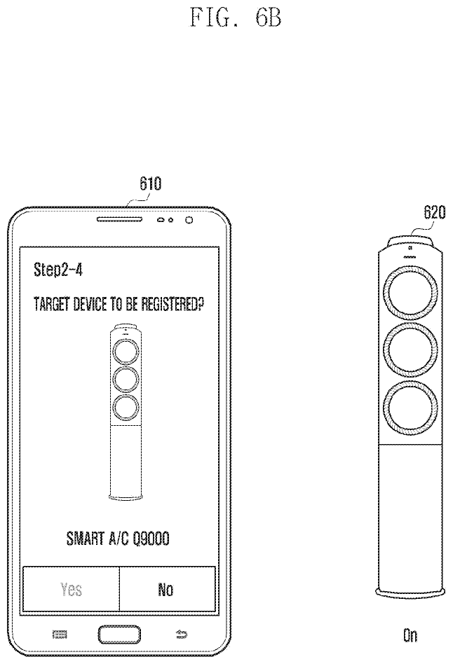

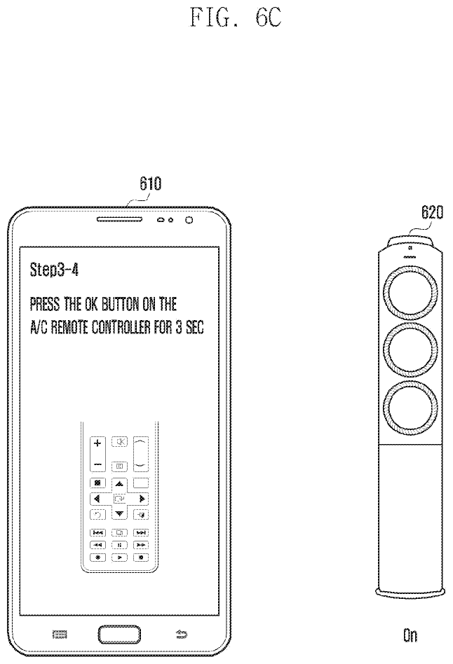

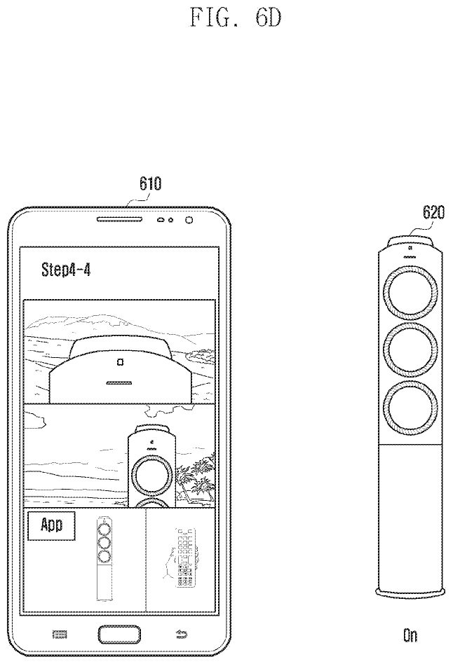

FIG. 5 is a flow diagram illustrating an example process of registering a smart home device in a home network according to an example embodiment of the present disclosure. FIGS. 6A, 6B, 6C and 6D are diagrams illustrating an example of the registration process illustrated in FIG. 5. In FIG. 5, the first line shows a flow of operations performed by the smart home device, whereas the second line shows a flow of operations performed by the registration supporting device.

Hereinafter, a process of registering the smart home device in the home network according to an example embodiment will be described with reference to FIG. 5 together with FIGS. 6A to 6D.

At operation 501, a registration supporting device 610 may execute a smart home mobile application for registering a smart home device 620, e.g., an air conditioner, under the control of the processor and then provide a user interface of the smart home application through the display as illustrated in FIG. 6A.

At operation 503, the smart home device 620 may be powered on, and thereby the communication module in the smart home device 620 may be powered on.

At operations 505 and 507, the communication module of the smart home device 620 may generate a registration signal. For example, the registration signal may be a beacon frame created in a broadcasting manner by the smart home device 620 that temporarily operates as an AP. For example, the beacon frame may be formed of a header, a frame body, a frame check sequence (FCS), and also include various kinds of information such as a timestamp, a beacon interval, a capability, a service set identifier (SSID), and supported rates. According to another embodiment, after being powered on, the smart home device 620 may temporarily operate as a Bluetooth device. For example, the smart home device 620 may temporarily generate an inquiry response message, as the registration signal, based on a Bluetooth protocol.

At operation 509, the registration supporting device 610 may search for the registration signal under the control of the processor. For example, the registration supporting device 610 may discover a neighboring AP and collect an SSID generated nearby through the communication module. According to another embodiment, the registration supporting device 610 may discover a neighboring Bluetooth device. For example, the registration supporting device 610 may collect a Bluetooth ID from a nearby inquiry response message.

At operations 511 and 513, the registration supporting device 610 may receive an SSID contained in the registration signal, e.g., the beacon frame, generated from the smart home device 620. The registration supporting device 610 may collect information about the smart home device 620 from the received SSID by referring to an internal memory or the home network sever under the control of the processor. For example, under the control of the processor, the registration supporting device 610 may offer the collected information about the smart home device 620 through the display and thereby request a user confirmation as shown in FIG. 6B. According to another embodiment, the registration supporting device 610 may receive an Bluetooth ID generated from the smart home device 620 and then collect information about the smart home device 620 from the received Bluetooth ID by referring to the internal memory or the home network server under the control of the processor.

At operation 515, the registration supporting device 610 may receive a registration request for the smart home device 620 from a user and then request an input of information about the connected home network.

At operations 517 and 519, the registration supporting device 610 may deliver the home network information, received from a user, to the server for authentication. If the home network information is valid, the registration supporting device 610 may transmit the home network information to the smart home device 620.

At operation 521, when a given period expires after the smart home device 620 is powered on, the smart home device 620 may stop generating the registration signal.

At operations 523 and 525, the smart home device 620 may display, through the display, that registration in the home network is in progress, and also request a user to finally confirm a connection. For example, after receiving the home network information, the smart home device 620 may request a user to finally confirm registration in the network. According to various embodiments, such a user's confirmation may be performed using a specific button, display or touch screen equipped on a body or remote controller of the smart home device 620. For example, as shown in FIG. 6C, the air conditioner 620 may request a user to press the OK button of the remote controller for three seconds when the user desires registration. Further, this requesting operation of the air conditioner 620 may be synchronized with operation of displaying a guide screen through the display of the registration supporting device 610. According to such embodiments, a user can perceive a way of finally confirming connection through the display of the smart home device 620 or the registration supporting devices 610 and then easily perform the registration process of the smart home device 620. After the final connection confirmation is received from a user, the smart home device 620 may try to access the home network (AP), based on the home network information received from the registration supporting device 610, and check a connection state with the home network.

At operations 527 and 529, after home network access and authentication are completed, the smart home device 620 may transmit a final connection confirmation message to the registration supporting device 610. For example, the final connection confirmation message may be delivered through the home network.

At operations 531 and 533, after the final connection confirmation message is received, the registration supporting device 610 may provide, through the display, a screen showing that the registration of the smart home device 620 is completed, as shown in FIG. 6D. Then, the registration supporting device 610 may also provide a user interface for inquiring information associated with the registered smart home device 620.

According to an embodiment of this disclosure, an electronic device, e.g., the registration supporting device, for registering the smart home device in the smart home system may include a display, a communication module, an input unit, a memory, and a processor electrically connected to the display, the communication module, the input unit, and the memory. In this electronic device, the processor may be configured to receive a registration signal from the smart home device, to determine whether the registration signal is not generated anymore, if there is no generation of the registration signal, to collect information about the smart home device by analyzing the received registration signal, if the registration signal is received again, to request a registration confirmation from a user by providing the information about the smart home device through the display, to request home network connection information from the user when the registration confirmation is received from the user, and to connect the smart home device to a home network by transmitting the home network connection information to the smart home device when the home network connection information is received from the user.

According to an embodiment of this disclosure, the above electronic device, i.e., the registration supporting device, may perform a method for registering the smart home device in the smart home system, the method including operations of receiving a registration signal from the smart home device; determining whether the registration signal is not generated anymore; if there is no generation of the registration signal, collecting information about the smart home device by analyzing the received registration signal; if the registration signal is received again, requesting a registration confirmation from a user by providing the information about the smart home device through a display; requesting home network connection information from the user when the registration confirmation is received from the user; and connecting the smart home device to a home network by transmitting the home network connection information to the smart home device when the home network connection information is received from the user.

Hereinafter, a smart home system and a method for registering a smart home device in the smart home system will be described in detail according to another embodiment of the present disclosure.

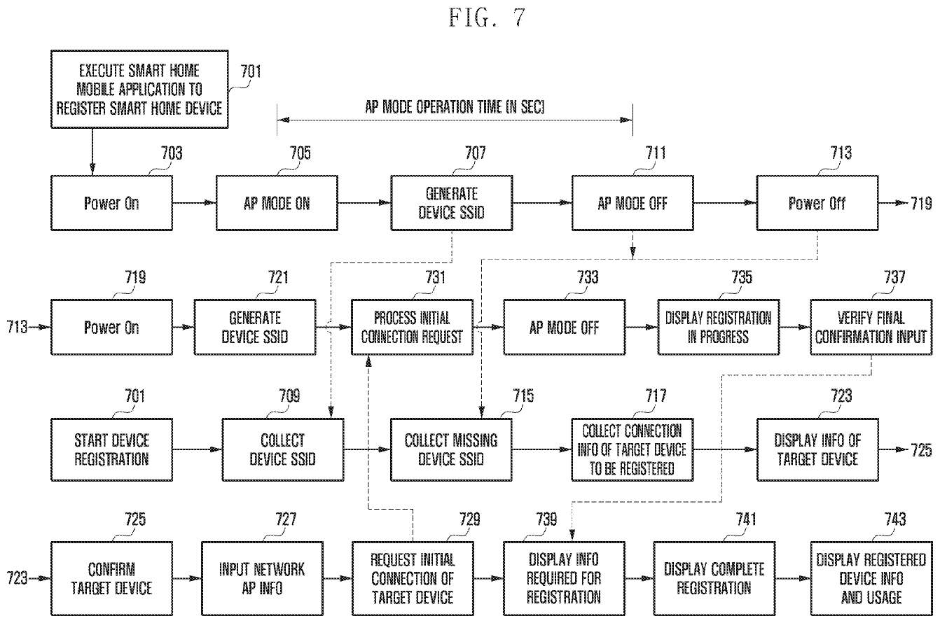

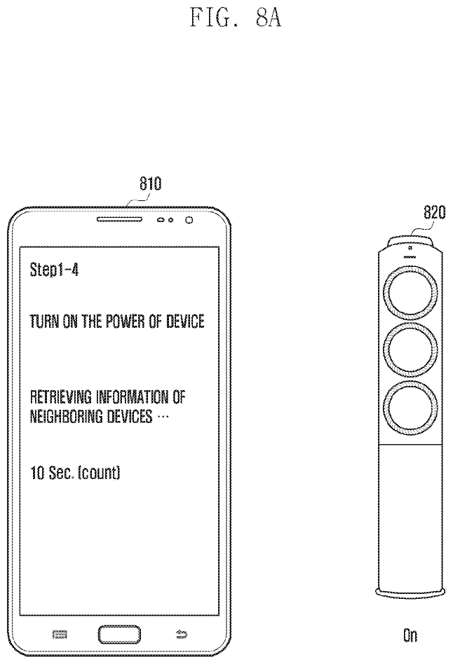

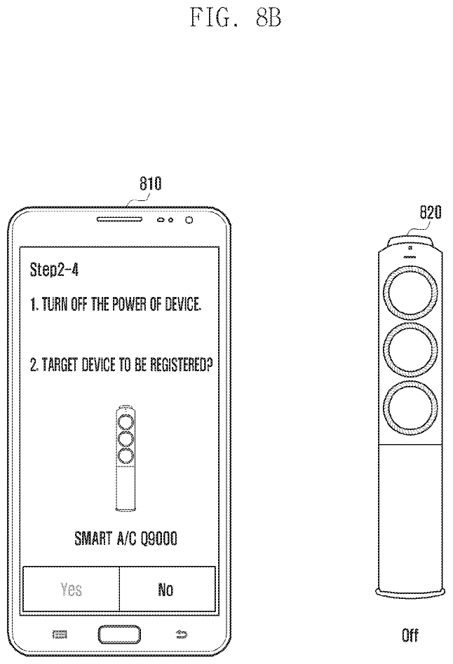

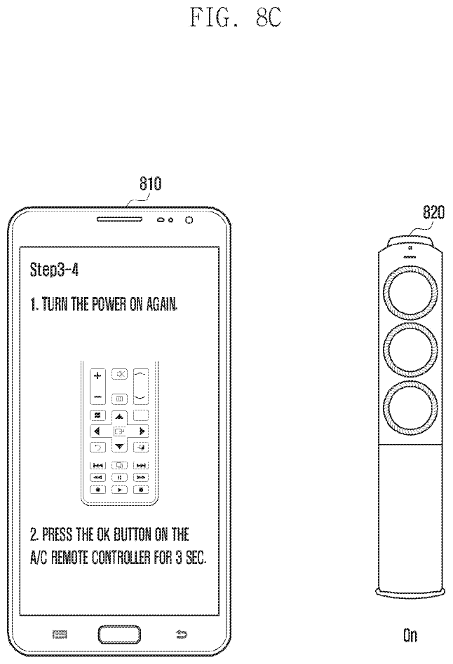

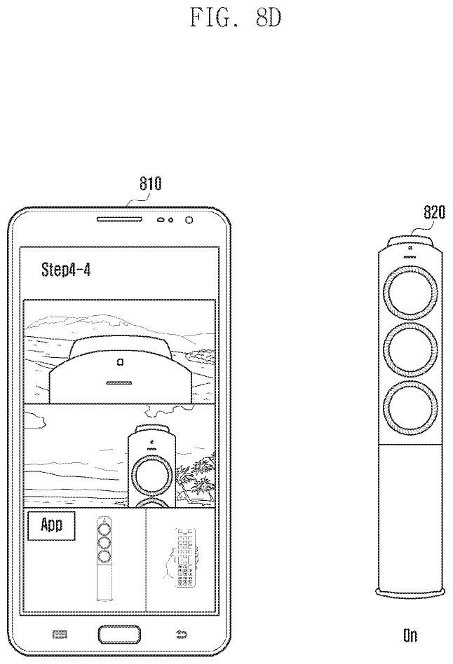

FIG. 7 is a flow diagram illustrating an example process of registering a smart home device in a home network according to another example embodiment of the present disclosure. FIGS. 8A, 8B, 8C and 8D are diagrams illustrating the registration process illustrated in FIG. 7. In FIG. 7, the first and second lines show a flow of operations performed by the smart home device, whereas the third and fourth lines show a flow of operations performed by the registration supporting device.

Hereinafter, a process of registering the smart home device in the home network according to another embodiment will be described with reference to FIG. 7 together with FIGS. 8A to 8D.

At operation 701, a registration supporting device 810 may execute a smart home mobile application for registering a smart home device 820, e.g., an air conditioner, under the control of the processor and then provide a user interface of the smart home application through the display as shown in FIG. 8A.

At operation 703, the smart home device 820 may be powered on, and thereby the communication module in the smart home device 820 may be powered on.

At operations 705 and 707, the communication module of the smart home device 820 may generate a registration signal. For example, the registration signal may be a beacon frame created in a broadcasting manner by the smart home device 820 that temporarily operates as an AP. For example, the beacon frame may be formed of a header, a frame body, a frame check sequence (FCS), and also include various kinds of information such as a timestamp, a beacon interval, a capability, a service set identifier (SSID), and supported rates. According to another embodiment, after being powered on, the smart home device 820 may temporarily operate as a Bluetooth device. For example, the smart home device 820 may temporarily generate an inquiry response message, as the registration signal, based on a Bluetooth protocol.

At operation 709, the registration supporting device 810 may search for a neighboring AP under the control of the processor. For example, the registration supporting device 810 may collect an SSID generated nearby through the communication module. According to another embodiment, the registration supporting device 810 may discover a neighboring Bluetooth device. For example, the registration supporting device 810 may collect a Bluetooth ID from a nearby inquiry response message.

At operations 711 and 713, the smart home device 820 may stop generating the registration signal when a given period expires after the smart home device 820 is powered on, or stop generating the registration signal when the smart home device 820 is powered off in response to a user's input.

At operations 715 and 717, the registration supporting device 810 may search for a signal, which stops being generated, from among previously received registration signals. For example, the registration supporting device 810 may recognize that the SSID received from the smart home device 820 is not generated anymore. The registration supporting device 810 may collect information about the smart home device 820 from the generation-stopped registration signal, e.g., the SSID, by referring to an internal memory or the home network sever. According to another embodiment, the registration supporting device 810 may recognize that the Bluetooth ID received from the smart home device 820 is not generated anymore. The registration supporting device 810 may collect information about the smart home device 820 from the generation-stopped registration signal, e.g., the Bluetooth ID, by referring to the internal memory or the home network server.

At operations 723 and 725, the registration supporting device 810 may provide the collected information about the smart home device 820 through the display under the control of the processor so as to request a user's confirmation as shown in FIG. 8B.

At operation 727, after a request for registration of the smart home device 820 is received from a user, the registration supporting device 810 may request an input of information about the connected home network.

At operations 719 and 721, the smart home device 820 may be powered on again in response to a user's input and then generate again a registration signal.

At operations 729 and 731, the registration supporting device 810 may deliver the home network information, received from a user, to the server for authentication. If the home network information is valid, the registration supporting device 810 may transmit the home network information to the smart home device 820.

At operation 733, when a given period expires after the smart home device 820 is powered on, the smart home device 820 may stop generating the registration signal.

At operations 735 and 737, the smart home device 820 may display, through the display, that registration in the home network is in progress, and also request a user to finally confirm a connection. For example, after receiving the home network information, the smart home device 820 may request a user to finally confirm registration in the network. According to various embodiments, such a user's confirmation may be performed using a specific button, display or touch screen equipped on a body or remote controller of the smart home device 820. For example, as shown in FIG. 8C, the air conditioner 820 may request a user to press the OK button of the remote controller for three seconds when the user desires registration. Further, this requesting operation of the air conditioner 820 may be synchronized with operation of displaying a guide screen through the display of the registration supporting device 810. According to such embodiments, a user can perceive a way of finally confirming connection through the display of the smart home device 820 or the registration supporting devices 810 and then easily perform the registration process of the smart home device 820. After the final connection confirmation is received from a user, the smart home device 820 may try to access the home network (AP), based on the home network information received from the registration supporting device 810, and check a connection state with the home network. After home network access and authentication are completed, the smart home device 820 may transmit a final connection confirmation message to the registration supporting device 810. For example, the final connection confirmation message may be delivered through the home network.

At operations 739 and 741, after the final connection confirmation message is received, the registration supporting device 810 may provide, through the display, a screen showing that the registration of the smart home device 820 is completed, as shown in FIG. 8D.

At operation 743, the registration supporting device 810 may also provide a user interface for inquiring information associated with the registered smart home device 820.

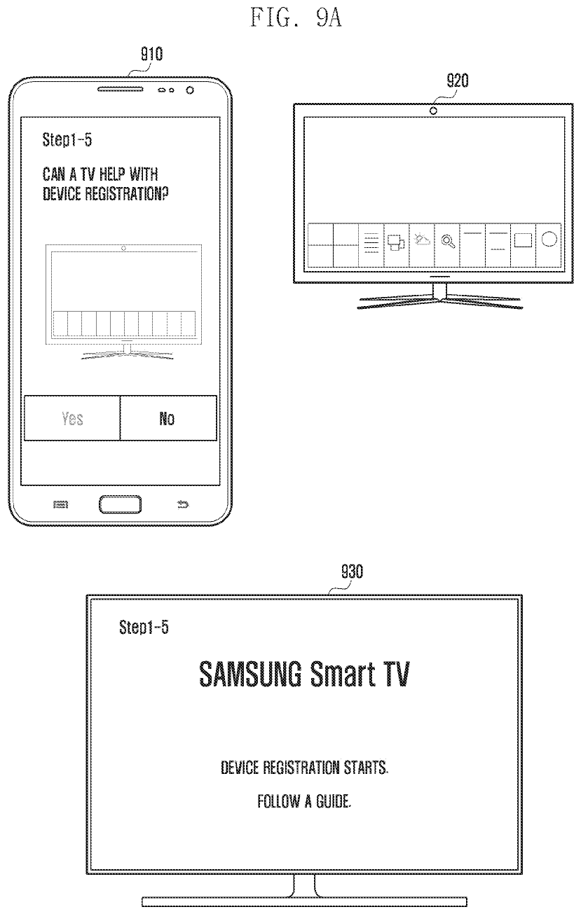

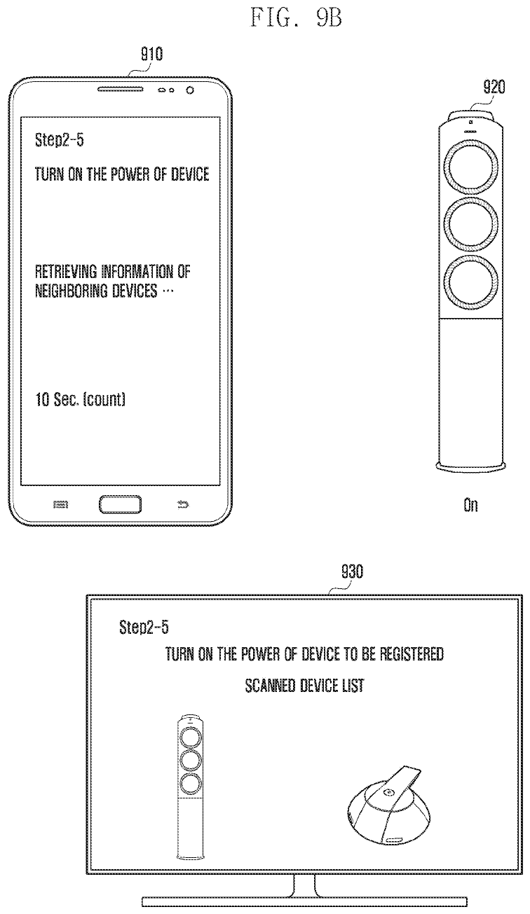

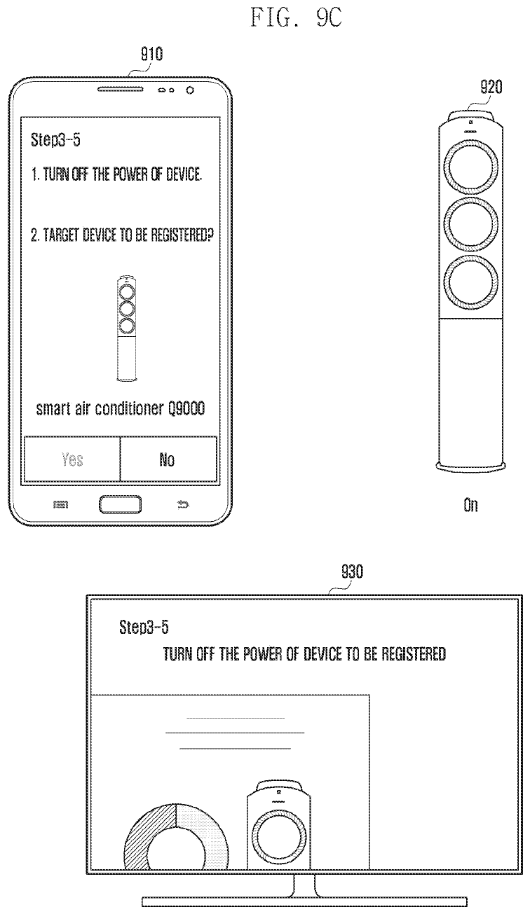

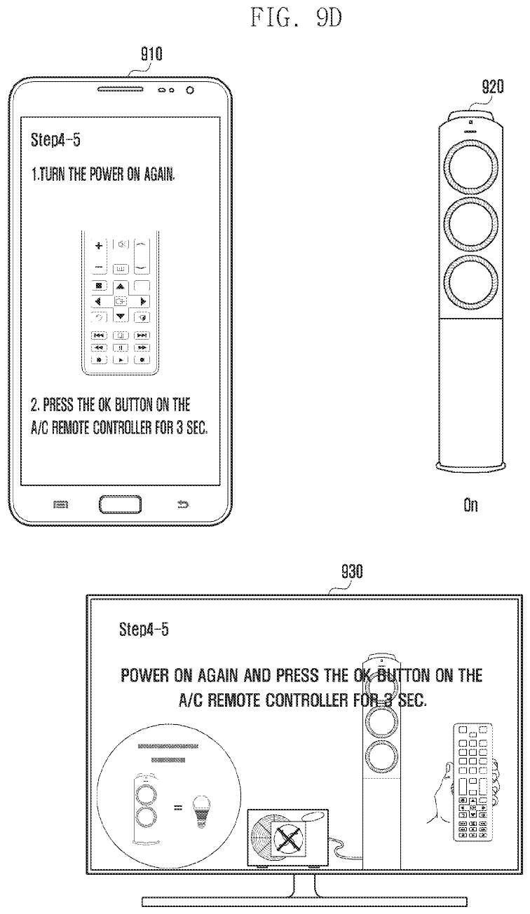

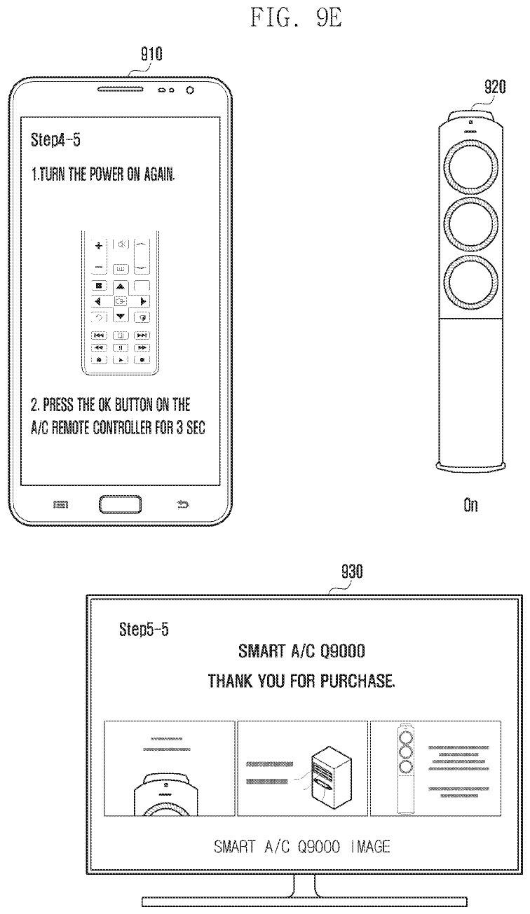

According to still another example embodiment as illustrated in FIGS. 9A, 9B, 9C, 9D and 9E, while another registration supporting device, e.g., a smart phone 910 provides a user interface of the smart home mobile application, a smart TV 930 may provide details of a registration process of a smart home device 920 by synchronizing with the user interface.

According to an embodiment of this disclosure, an electronic device, e.g., the registration supporting device, for registering the smart home device in the smart home system may include a display, a communication module, an input unit, a memory, and a processor electrically connected to the display, the communication module, the input unit, and the memory. In this electronic device, the processor may be configured to request, through the display, a user to move the remote controller near the smart home device, if the smart home device recognizes an approach of the remote controller and generates a notification, to identify the smart home device according to the notification received through the remote controller, to request a registration confirmation from the user by providing information about the smart home device through the display, to request home network connection information from the user when the registration confirmation is received from the user through the input unit, and to connect the smart home device to a home network by transmitting the home network connection information to the smart home device when the home network connection information is received from the user.

According to an embodiment of this disclosure, the above electronic device, e.g., the registration supporting device, may perform a method for registering the smart home device in the smart home system, the method including operations of requesting, through a display, a user to move a remote controller near the smart home device; if the smart home device recognizes an approach of the remote controller and generates a notification, identifying the smart home device according to the notification received through the remote controller; requesting a registration confirmation from the user by providing information about the smart home device through the display; requesting home network connection information from the user when the registration confirmation is received from the user through the input unit; and connecting the smart home device to a home network by transmitting the home network connection information to the smart home device when the home network connection information is received from the user.

Hereinafter, a smart home system and a method for registering a smart home device in the smart home system will be described in detail according to still another example embodiment of the present disclosure.

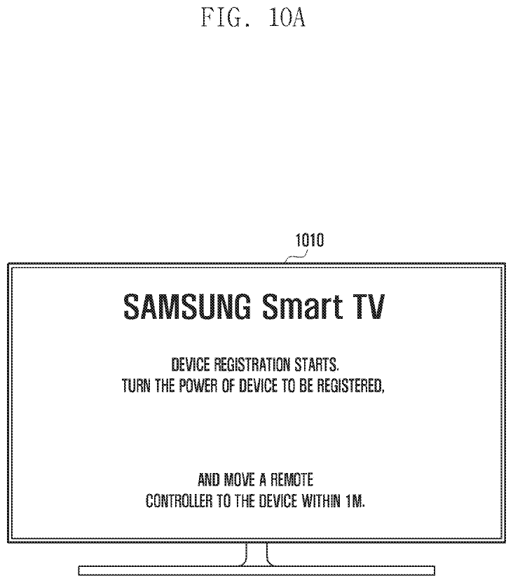

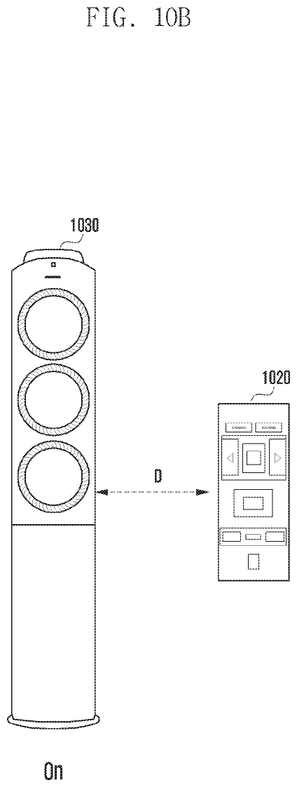

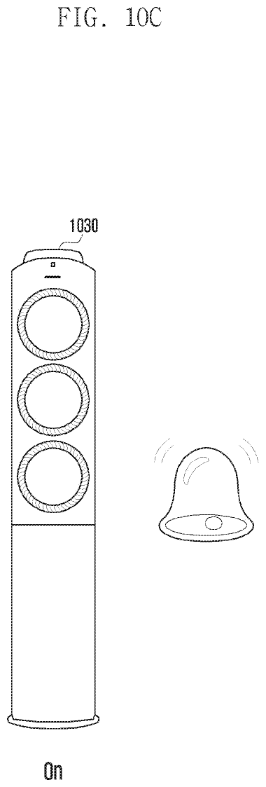

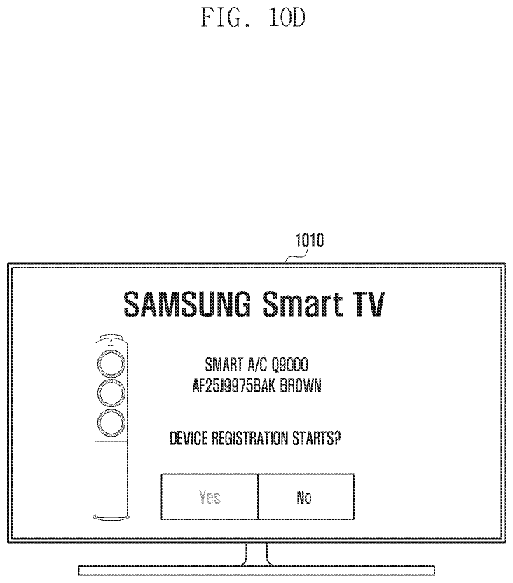

FIGS. 10A, 10B, 10C and 10D are diagrams illustrating an example process of registering a smart home device in a home network according to yet another example embodiment of the present disclosure.

Hereinafter, a process of registering the smart home device in the home network according to still another example embodiment will be described with reference to FIGS. 10A to 10D.

Referring to FIG. 10A, the registration supporting device may be a display device having a smart remote controller 1020 (hereinafter, a remote controller). For example, the registration supporting device may be a smart TV 1010. For example, the smart TV 1010 may execute a smart home TV application under the control of the processor and then provide a user interface contained in the smart home TV application through the display. For example, when a smart home device 1030 is powered on, the smart TV 1010 may display a screen that requests a user to move the remote controller 1020 to the smart home device 1030 to be registered.

Referring to FIG. 10B, the smart home device 1030 may determine whether the remote controller 1020 of the smart TV 1010 approaches within a specific distance (D). For example, after powered on, each of the smart home device 1030 and the remote control 1020 may generate a registration signal. This registration signal may be a beacon signal. The smart home device 1030 may not only generate the registration signal, but also detect the strength of the registration signal generated by the remote controller 1020.

Referring to FIG. 10C, the smart home device 1030 may generate a notification when the remote controller 1020 of the smart TV 1010 approaches within the specific distance (D). For example, if the strength of the registration signal generated by the remote controller 1020 is detected greater than a given reference value, the smart home device 1030 may generate the notification. In response to the notification generated by the smart home device 1030, the smart TV 1010 may collect information about the smart home device 1030 through the remote controller 1020.

Referring to FIG. 10D, the smart TV 1010 may not only provide the collected information about the smart home device 1030 through the display, but also request a user to confirm whether to register the smart home device 1030. After receiving a user's confirmation, the smart TV 1010 may support the registration of the smart home device 1030. This process may be the same as or similar to the above-discussed operations after the operation 513 in FIG. 5.

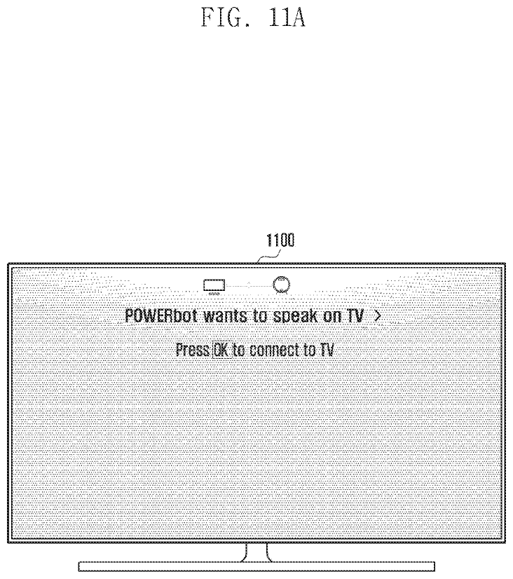

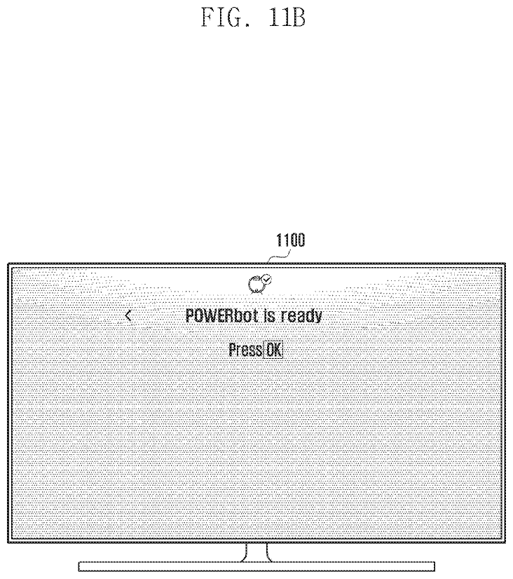

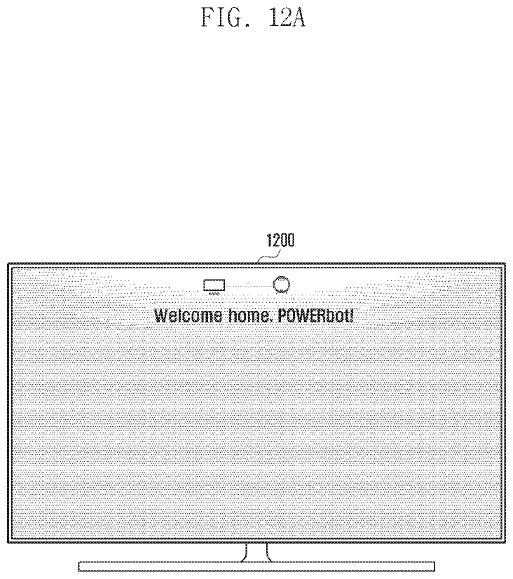

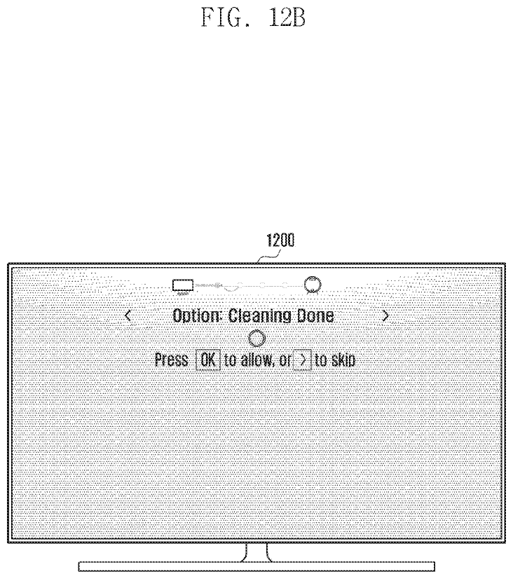

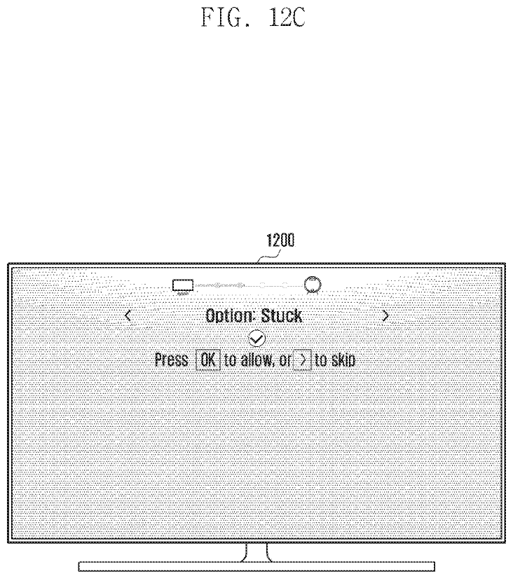

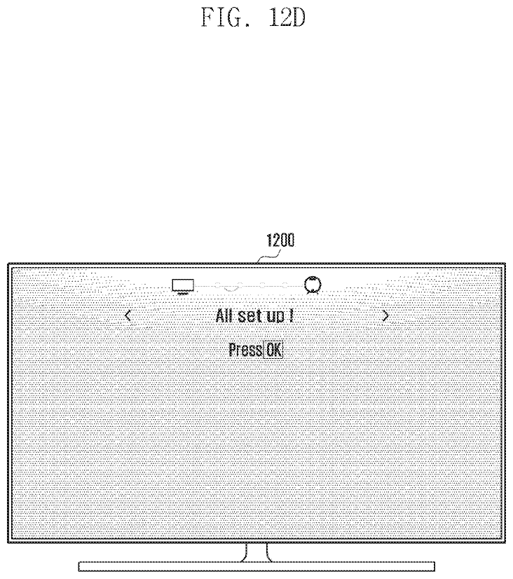

FIGS. 11A and 11B are diagrams illustrating an example service provided by a smart TV after registration of a smart home device according to an example embodiment of the present disclosure. FIGS. 12A, 12B, 12C and 12D are diagrams illustrating an example service provided by a smart TV after registration of a smart home device according to another example embodiment of the present disclosure.

According to an example embodiment, after the above process of connecting a specific smart home device to the home network is completed, a smart TV 1100 may further provide a service associated with the smart home device. For example, as illustrated in FIG. 11A, the smart TV 1100 may display basic information about the registered smart home device.

After displaying the basic information about the registered smart home device, the smart TV 1100 may request, as illustrated in FIG. 11B, a user to confirm whether to receive detailed information associated with the registered device. For example, a user may perform setting about whether to receive a basic notification and/or detailed notifications about the registered smart home device, using the input unit, e.g., the remote controller, in various input manners such as a physical input, a voice input, or a gesture input. For example, in case the registered smart home device is a vacuum cleaner, the smart TV 1100 may provide various types of information such as cleaning done information, stuck error information, or maintenance status information, depending on notification setting.

According to another example embodiment, the smart TV may allow a user to select step by step a notification about the registered smart home device, and then provide the selected notification only. For example, as shown in FIG. 12A, the smart TV 1200 may display the registered smart home device. Then, if the registered smart home device is a vacuum cleaner, the smart TV 1200 may request, as shown in FIG. 12B, a user to confirm whether to receive the cleaning done information. Also, as shown in FIG. 12C, the smart TV 1200 may request a user to confirm whether to receive the stuck error information. After all steps of selecting notifications, as shown in FIG. 12D, the smart TV 1200 may provide information indicating that all setup is completed.

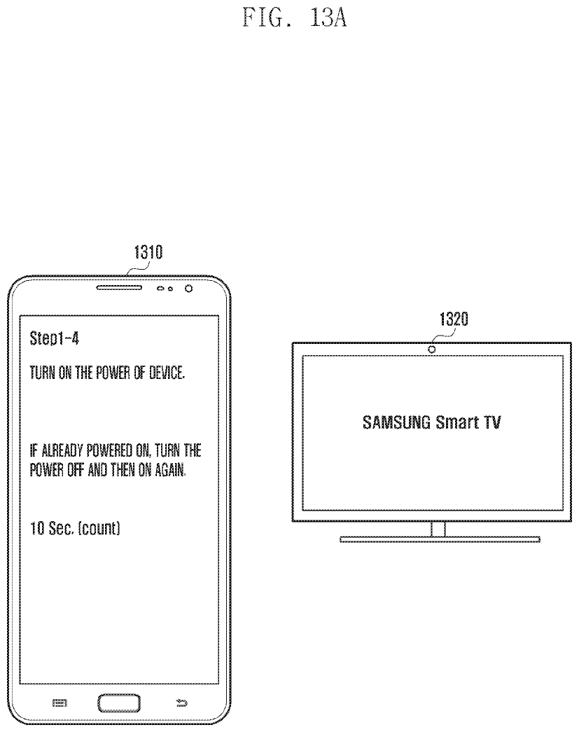

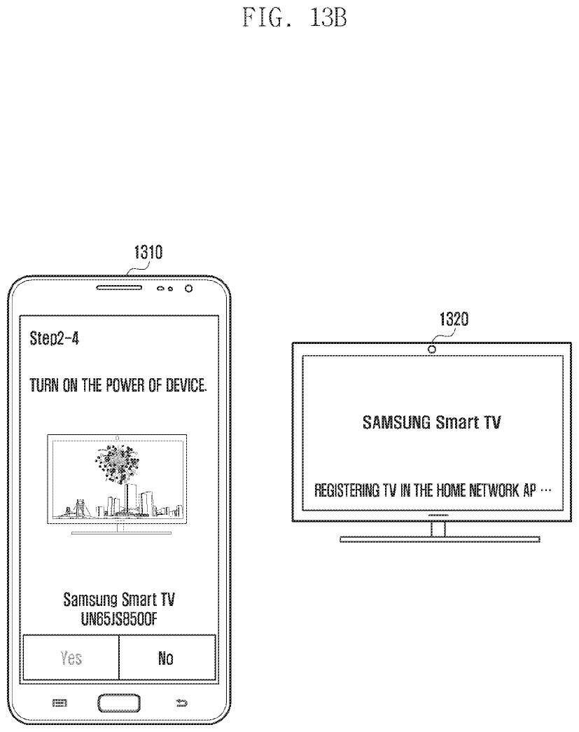

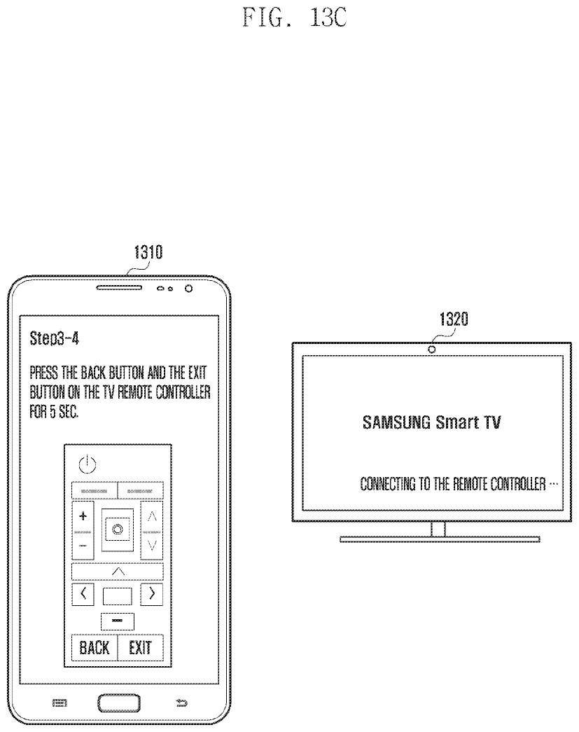

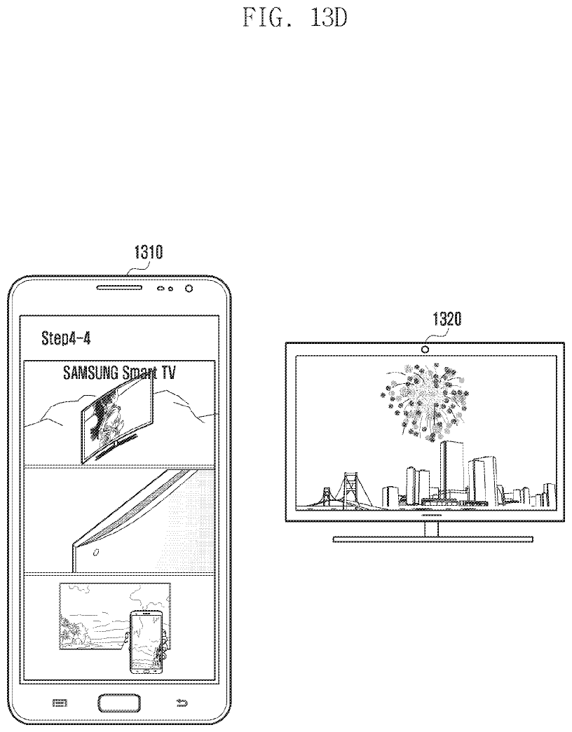

According to a certain embodiment, in case a new smart TV 1320 is purchased while the smart home system has been already constructed, a process of registering the new smart TV in the home network is the same as or similar to the above-discussed process. For example, referring to FIGS. 13A, 13B, 13C and 13D, the smart TV 1320, even though operating as the registration supporting device, may require a process of being registered as the home network device at the beginning of purchase. This process of registering the smart TV 1320 in the home network may be performed through a smart phone 1310 and may be the same as or similar to the above-discussed process in FIG. 5 or 7.

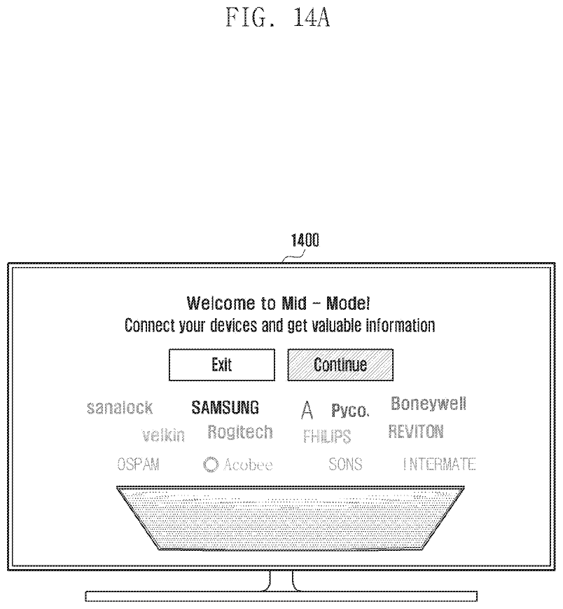

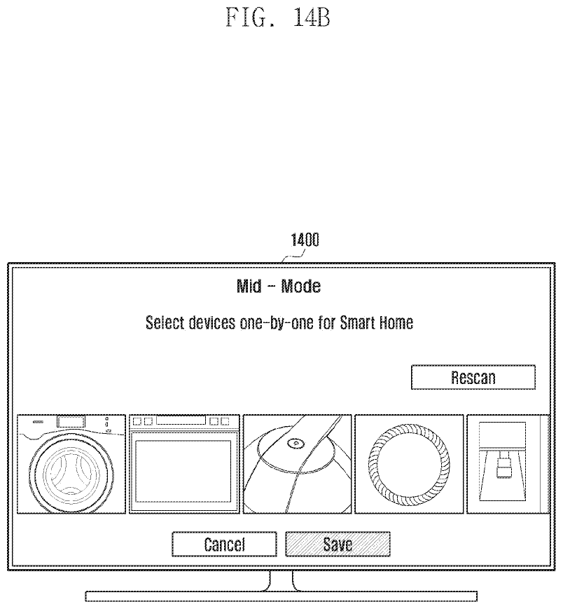

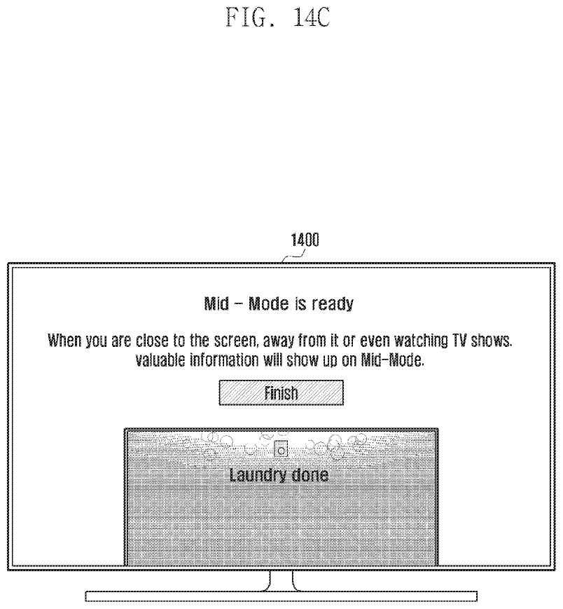

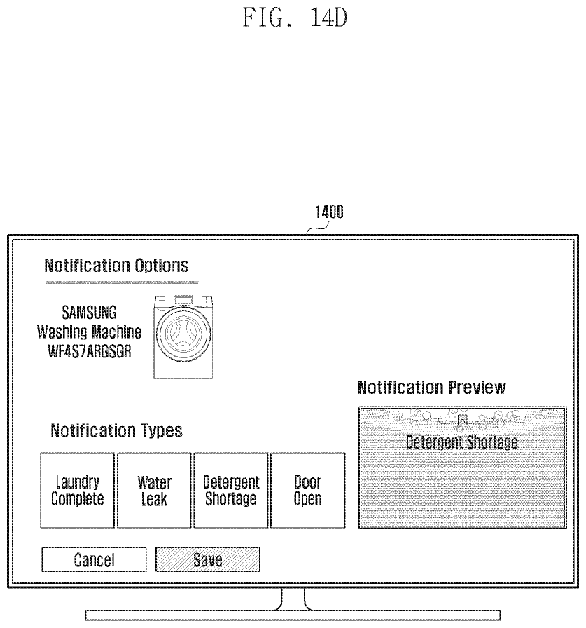

FIGS. 14A, 14B, 14C and 14D are diagrams illustrating an example service provided after initial registration of a new smart TV according to an example embodiment of the present disclosure.

According to an example embodiment, in case a new smart TV 1400 is purchased and then registered, the smart TV 1400 may provide the following service. For example, the smart TV 1400 may provide an initial setting screen as shown FIG. 14A.

After displaying the initial setting screen, the smart TV 1400 may request a user input for selecting a device to link with an additional function as shown FIG. 14B. The device to link with an additional function may be any other smart home device already connected to the existing home network.

After any device is selected in response to a user input, the smart TV 1400 may provide, as shown in FIG. 14C, a preview about a notification to be provided through the smart TV 1400.

Referring to FIG. 14D, the smart TV 1400 may provide on the screen a menu of detailed setting options for the selected device. At this time, the smart TV 1400 may further provide simple basic information about the selected device. Then, in response to a user input, the smart TV 1400 may enter into a selected setting option. For example, if the selected device is a washing machine, the smart TV 1400 may provide a menu of detailed setting options such as a laundry complete, a water leak, or a detergent shortage and request a user to receive a notification about such options.

As fully described hereinbefore, according to various embodiments of this disclosure, it is possible to simply connect smart home devices to the home network in the same manner regardless of kinds of smart home devices.

A programming module according to embodiments of the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

While the disclosure has been shown and described with reference to certain embodiments thereof, it will be understood by those skilled in the art that various changes in form and detail may be made therein without departing from the spirit and scope of the disclosure as defined by the appended claims.

1-12. (canceled)

13. An electronic device configured to register an external device in a smart home network, the electronic device comprising:
a display;
a short-range wireless communication module;
an input device;
a memory; and
a processor configured to:
control the display to display a first message guiding a user to turn on the external device;
detect, after displaying the first message, a signal indicating that the external device is turned on, the signal being periodically transmitted from the external device to the electronic device through the short-range wireless communication module,
control the display to display a second message guiding the user to turn off the external device,
identify, after displaying the second message, whether the signal transmitted from the external device is detected or not,
determine, based on identifying that the signal is not detected, that the external device is a device to be newly registered in the smart home network,
obtain information related to the external device by analyzing the signal,
control the display to display the obtained information related to the external device and a third message guiding the user to turn on the external device, and
transmit, based on detecting a signal indicating that the external device is turned on, connection information of the smart home network to the external device.

14. The electronic device of claim 13, wherein the signal transmitted from the external device includes a beacon frame based on a WiFi protocol.

15. The electronic device of claim 13, wherein the signal transmitted from the external device includes an inquiry response message based on a Bluetooth protocol.

16. The electronic device of claim 13, wherein the processor is configured to obtain the connection information of the smart home network based on a user input.

17. The electronic device of claim 13, wherein the processor is configured to, in response to the external device connecting to the smart home network, provide a notification related to a current status of the external device, an error occurrence of the external device, or an operation completion of the external device.

18. A method for registering an external device in a smart home network by an electronic device, the method comprising:
controlling a display to display a first message guiding a user to turn on the external device;
detecting, after displaying the first message, a signal indicating that the external device is turned on, the signal being periodically transmitted from the external device to the electronic device through a short-range wireless communication module,
controlling the display to display a second message guiding the user to turn off the external device,
identifying, after displaying the second message, whether the signal transmitted from the external device is detected or not,
determining, based on identifying that the signal is not detected, that the external device is a device to be newly registered in the smart home network,
obtaining information related to the external device by analyzing the signal,
controlling the display to display the obtained information related to the external device and a third message guiding the user to turn on the external device, and
transmitting, based on detecting a signal indicating that the external device is turned on, connection information of the smart home network to the external device.

19. The method of claim 13, wherein the signal transmitted from the external device includes a beacon frame based on a WiFi protocol.

20. The method of claim 13, wherein the signal transmitted from the external device includes an inquiry response message based on a Bluetooth protocol.

21. The method of claim 13, further comprising obtaining the connection information of the smart home network based on a user input.

22. The method of claim 13, further comprising, in response to the external device connecting to the smart home network, providing a notification related to a current status of the external device, an error occurrence of the external device, or an operation completion of the external device.
